(19) United States
(12) Patent Application Publication
(10) Pub. No.: US 2009/0204294 A1
(43) Pub. Date: Aug. 13, 2009

(54) Method for Generating a Triggering Signal for a Passenger Protection Device

(76) Inventors: Frank Mack, Seoul (KR); Josef Kolatschek, Weil Der Stadt (DE); Markus Krieg, Dellfeld (DE)

Correspondence Address: KENYON & KENYON LLP, ONE BROADWAY, NEW YORK, NY, 10004, US

(21) Appl. No.: 11/886,924

(22) PCT Filed: Jan. 31, 2006
(86) PCT No.: PCT/EP2006/050545

§ 371 Date: Jan. 26, 2008

(30) Foreign Application Priority Data
Mar. 24, 2005 (DE) 10 2005 013 595.1

(51) Int. Cl. B60R 21/0134

(52) U.S. Cl. 701/45

(57) ABSTRACT

A method for generating a triggering signal for a passenger protection device in which sensor data are detected and analyzed for accident classification, and to a corresponding device. To determine a relative accident velocity, signals of at least two measuring points offset by a predefined distance in the x direction are analyzed, and the time interval between a crash signal detected by a first sensor at a first measuring point and a crash signal detected by another sensor at another measuring point is determined.

### FIELD OF THE INVENTION

The present invention is directed to a device for generating a triggering signal for a passenger protection device.

### BACKGROUND INFORMATION

Due to the announcement of the introduction of an EU law for reducing injuries to a pedestrian in the event of a collision between a pedestrian and a vehicle, new vehicles must be designed in such a way that the injuries to the pedestrian in a collision remain within the limits required by this EU law.

A first strategy for reducing injuries to pedestrians aims at creating a crumple zone for the pedestrian via modifications in the bumper and the vehicle design to thus reduce the risk of injury via a passive approach.

A second strategy attempts to recognize the impact of a pedestrian by using a suitable sensor system and by subsequently activating a pedestrian protection device such as, for example, an external airbag on the A pillars and/or by creating the required crumple zone by lifting the engine hood. The most diverse sensor principles, such as acceleration sensors, pressure sensors, knock sensors, piezoelectric and/or optical sensors, etc. may be used in the active approach.

In addition, methods and devices for generating triggering signals for passenger protection devices are known such as, for example, airbags, seatbelt tensioners, etc., which have a plurality of sensors for accident detection and accident classification. Sensors known as upfront sensors may be used in a front crash zone to achieve early accident recognition and accident classification.

### SUMMARY OF THE INVENTION

The method for generating a triggering signal for a passenger protection device having the features described herein may have the advantage that the relative velocity may be very accurately determined in the event of an accident by analyzing signals which are detected by sensors at at least two measuring points offset by a predefined distance in the x direction. Low-speed accidents with hard obstacles, for example, an impact at a velocity of 15 km/h against a rigid wall, in which the passenger protection arrangement is not to be triggered, may thus be distinguished from high-speed accidents with less hard obstacles, for example, in the event of an impact at a velocity of 64 km/h against a deformable barrier, in which the passenger protection arrangement should be triggered. In systems without upfront sensors this represents a difficult problem, since central sensors designed as acceleration sensors, which are typically situated on the transmission tunnel, measure similar acceleration signals in both cases.

Knowing the exact relative accident velocity advantageously makes a reliable and robust activation of the passenger protection devices possible when a triggering signal is generated. Optimum protection of the passengers may thus be ensured while minimizing the costs incurred due to unintended triggering of the passenger protection device. The method according to the present invention advantageously decides, on the basis of the available sensor signals and taking into account the relative velocity, whether or not activation of the passenger protection device is required in the present situation after a collision with an object has been recognized.

The device according to the present invention for generating a triggering signal for a passenger protection device having the features described herein includes an arrangement for carrying out the method according to the present invention for generating a triggering signal for a passenger protection device.

The measures and refinements described herein make advantageous improvements on the method for generating a triggering signal for a passenger protection device specified herein and on the corresponding device specified herein.

It is advantageous in particular that the signals of at least two sensors of a pedestrian protection device are analyzed. The same sensors may thus be used for both pedestrian recognition and as upfront sensors for accident recognition and/or accident classification to enable optimum triggering of the passenger protection arrangement such as, for example, airbags, seat belt tensioners, etc. The costs for the additional upfront sensors may thus be saved.

At least three measuring points may be situated symmetrically in a vehicle bumper, for example, for determining the relative accident velocity; the signals from these measuring points are detected by corresponding acceleration sensors, a first measuring point being situated in the center of the vehicle bumper, a second measuring point to the left of the first measuring point in the direction of travel, and a third measuring point to the right of the first measuring point in the direction of travel. The predefined distance corresponds to a perpendicular distance of the first measuring point to an imaginary connecting line between the second and third measuring points. The distance is predefined by the shape of the bumper which in general has a curved design, so that the second and third measuring points are further back from the first measuring point in the direction of travel by the predefined distance. If an obstacle is now encountered, initially the first acceleration sensor generates a crash signal at this point in time. Only after a certain time interval do the two outer acceleration sensors also generate a crash signal on the basis of the impact, namely exactly at the point in time when the other acceleration sensors contact the object encountered. If the time period required for traveling the predefined distance is known, the relative accident velocity may be advantageously calculated from this information.

Due to the arrangement of the at least two measuring points offset in the x and/or the y direction, the signals detected by the corresponding acceleration sensors may advantageously also be analyzed for determining a time of impact and/or a point of impact.

The point in time of the first crash signal detected by one of the acceleration sensors is output, for example, as the time of impact. By analyzing the signals of the second and third acceleration sensors it is possible to recognize whether a symmetrical or an asymmetrical impact has occurred. The method according to the present invention may thus provide the same recognition performance by analyzing the acceleration sensors of the pedestrian protection system as does a precrash system, without an expensive forward-looking sensor unit being required.

In addition, the method according to the present invention is advantageously fully unaffected by weather conditions and may be used for any object and in all velocity ranges, while many of the conventional forward-looking systems may have signal detection problems when operating with certain objects, under certain weather conditions or at certain velocities.

The determined relative accident velocity and/or the determined time of impact and/or the determined symmetry are made advantageously available to the subsequent triggering operation for a personal protective arrangement, i.e., the determined features may be used for both triggering devices for the passenger protection arrangement, and for triggering devices for the pedestrian protection arrangement.

An exemplary embodiment of the present invention is depicted in the drawings and elucidated in greater detail in the description that follows.

### DESCRIPTION OF THE DRAWINGS

FIG. 1 shows a schematic block diagram of a device for carrying out the method according to the present invention.

FIG. 2 shows a distance/time diagram for determining time difference Δt as a function of a distance d.

FIG. 3 schematically shows acceleration signals in a crash at a velocity of 15 km/h against a rigid wall.

FIG. 4 schematically shows extreme values of the acceleration signals in a crash at a velocity of 15 km/h against a rigid wall.

FIG. 5 schematically shows acceleration signals in an offset crash at a velocity of 64 km/h against a deformable barrier.

FIG. 6 schematically shows extreme values of the acceleration signals in an offset crash at a velocity of 64 km/h against a deformable barrier.

### DETAILED DESCRIPTION

Vehicles have a plurality of sensors for accident recognition and accident classification. Sensors known as upfront sensors are typically used in a front crash zone to achieve early accident recognition and accident classification. In addition, pedestrian protection systems having acceleration sensors situated in the vehicle bumper are known, the signals of the acceleration sensors being analyzed to recognize a collision with a pedestrian and to support a triggering decision for a pedestrian protection arrangement.

According to the exemplary embodiments and/or exemplary methods of the present invention, in order to determine a relative accident velocity, signals of at least two measuring points offset by a predefined distance in the x direction are analyzed, the time interval between a crash signal detected by a first sensor at a first measuring point and a crash signal detected by another sensor at another measuring point being determined.

The sensors for signal detection may be situated, for example, at the particular measuring points or mechanically coupled to the particular measuring points, in such a way that an impact on the bumper is immediately transmitted to the corresponding sensor due to the proper mechanical coupling. The sensors are preferably designed as acceleration sensors, each crash signal corresponding to a peak value of the acceleration signal detected by the particular acceleration sensor.

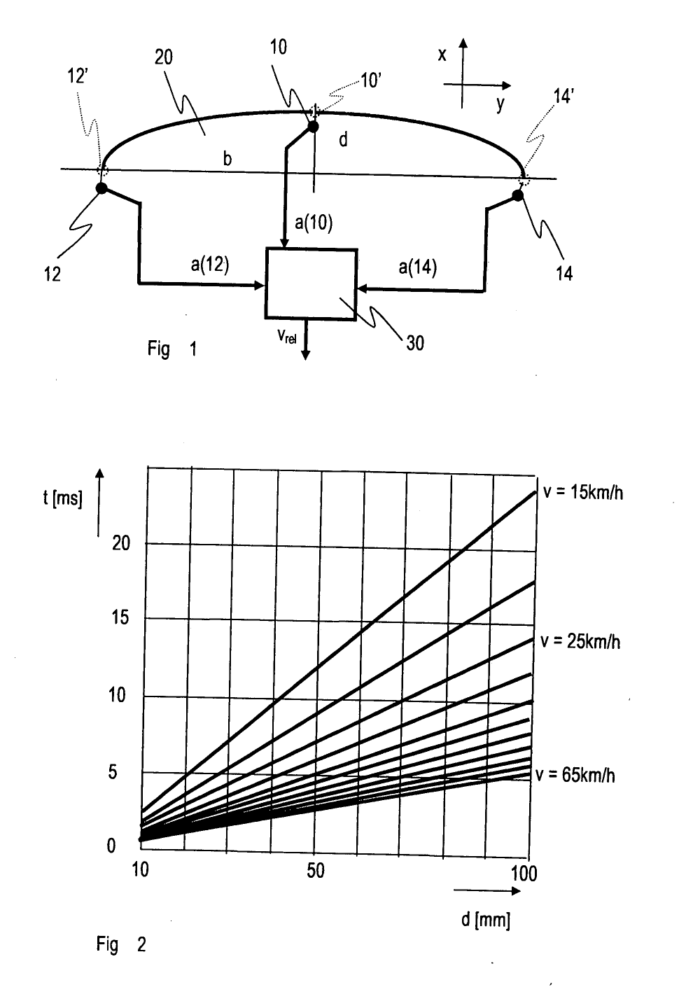

As is apparent from FIG. 1, an exemplary embodiment of a device for carrying out the method for generating a triggering signal for passenger protection devices includes three acceleration sensors 10, 12, 14 situated in a vehicle bumper 20 and an analyzing and a control unit 30, which receives and analyzes signals a(10), a(12), a(14) of acceleration sensors 10, 12, 14. Acceleration sensors 10, 12, 14 are each mechanically coupled to measuring points 10′, 12′, 14′ represented by dotted lines, so that an impact is immediately transmitted to the corresponding sensor 10, 12, 14. In an alternative specific embodiment (not depicted), measuring points 10′, 12′, 14′, and the installation sites of the corresponding sensors 10, 12, 14 coincide, so that the particular sensor detects an impact directly.

As is further apparent from FIG. 1, the three measuring points 10′, 12′, 14′ are situated symmetrically in vehicle bumper 20, a first acceleration sensor 10 being coupled to a first measuring point 10′ situated in the center of vehicle bumper 20, a second acceleration sensor 12 being coupled to a second measuring point 12′ situated to the left of first measuring point 10′ in the direction of travel, and a third acceleration sensor 14 being coupled to a third measuring point 14′ situated to the right of first measuring point 10′ in the direction of travel. First measuring point 10′ is situated offset with respect to second measuring point 12′ or to third measuring point 14′ by a predefined distance d in the x direction. Predefined distance d corresponds to a perpendicular distance of first measuring point 10′ to an imaginary connecting line b between second and third measuring points 12′, 14′. Distance d is predefined by the shape of vehicle bumper 20. Since bumper 20 typically has a curved design, in the depicted system second and third measuring points 12′, 14′ are further back from first measuring point 10′ by a distance d. If now an obstacle is encountered, initially first sensor 10 registers a crash signal, i.e., acceleration signal a(10) having a peak value. Only after a certain time interval Δt do also the second and/or third acceleration sensors 12, 14 register a crash signal, i.e., acceleration signals a(12) and/or a(14) having a peak value, namely at the point in time when the second measuring point 12′ and/or third measuring point 14′ contact the object encountered. To determine a relative accident velocity vᵣₑₗ, analyzing and control unit 30 ascertains time interval Δt between the crash signal detected by first acceleration sensor 10 and the crash signal detected by second and/or third acceleration sensor 12, 14. Each crash signal corresponds to the peak value of acceleration signals a(10), a(12), a(14) detected by the particular acceleration sensor 10, 12, 14. Since distance d between the measuring points is known, relative accident velocity vᵣₑₗ may be calculated using equation (1)

vᵣₑₗ=d/Δt (1)

Distance d of first measuring point 10′ to imaginary connecting line b between second and third measuring points 12′, 14′ is in the range of 5 cm to 15 cm depending on the design. Relative accident velocity vᵣₑₗ may thus be determined over the relevant accident velocity range of 15 km/h to 65 km/h within 3 ms to 25 ms. FIG. 2 shows a distance/time diagram with multiple velocity characteristic curves in the range of 15 km/h to 65 km/h for determining time difference Δt as a function of distance d. The difference between two adjacent velocity characteristic curves is 5 km/h. In the present exemplary embodiment, distance d=80 mm.

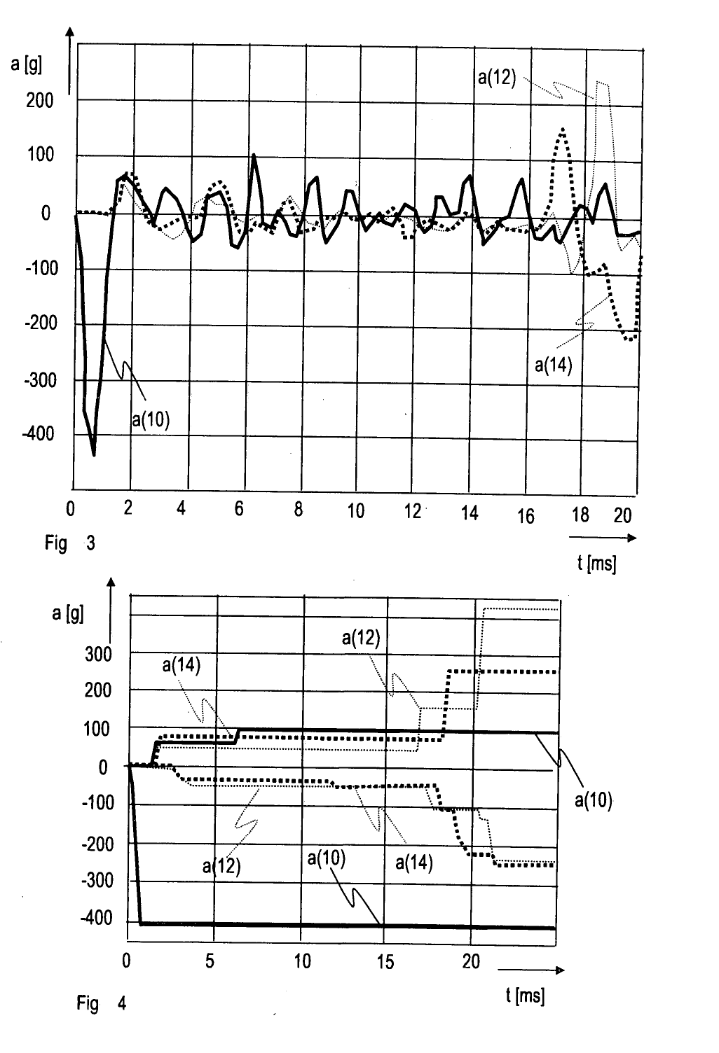

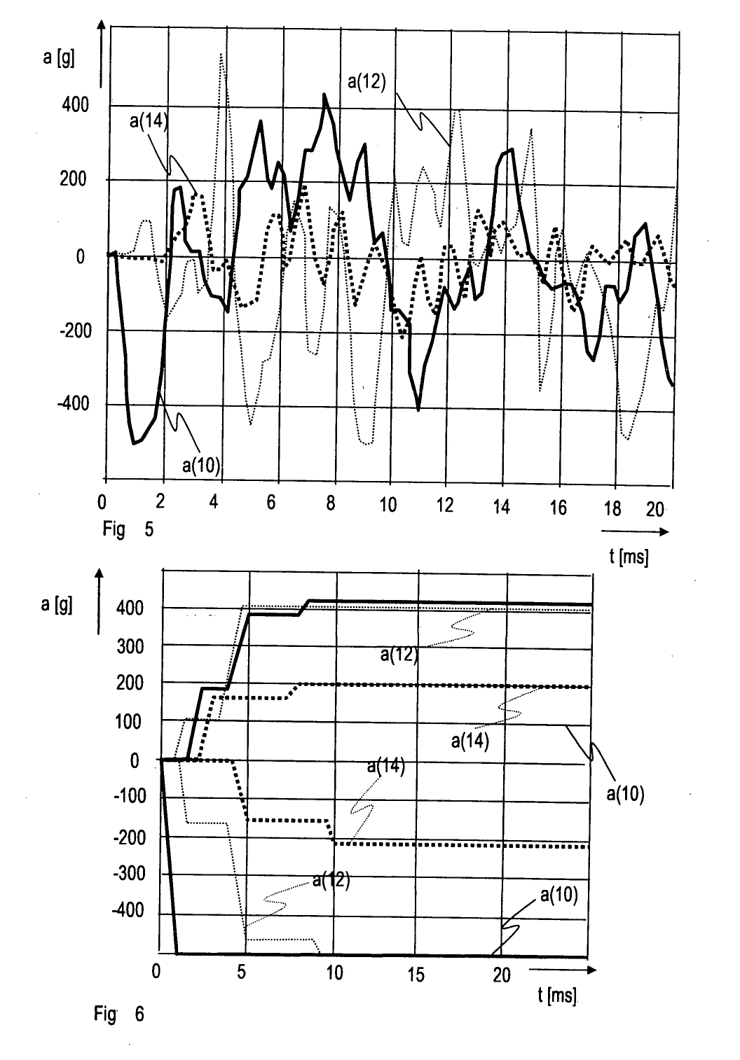

To calculate relative accident velocity vᵣₑₗ, analyzing and control unit 30 determines the extreme values of acceleration signals a(10), a(12) and a(14). Calculated relative accident velocity vᵣₑₗ may be used for improving the accident classification, i.e., for better determining the severity of the accident. Subsequently the determination of the extreme values of acceleration signals a(10), a(12) und a(14) will be described with reference to FIGS. 3 through 6. FIGS. 3 and 4 show signals which are generated in an accident at a low velocity of 15 km/h with a rigid wall, and FIGS. 5 and 6 show signals which are generated in an accident at a higher velocity of 64 km/h with a deformable barrier.

FIG. 3 shows acceleration signals a(10), a(12), a(14) of the three acceleration sensors 10, 12, 14 in the event of an impact at a velocity of 15 km/h against a rigid wall. The corresponding extreme values of acceleration signals a(10), a(12), a(14) obtained are illustrated in FIG. 4. As is apparent from FIGS. 3 and 4, first acceleration sensor 10 measures an acceleration peak value after approximately 1 ms. Second and third acceleration sensors 12, 14 register an acceleration that is considerably greater than 150 g (acceleration of the earth's gravity g=9.81 m/s²) after 20 ms have elapsed. Analyzing and control unit 30 thus ascertains a time difference Δt=19 ms between the peak value of first acceleration signal a(10) and the peak value of second and/or third acceleration signal a(12), a(14). With the predefined distance d of 80 mm, equation (1) yields a relative accident velocity vᵣₑₗ=80 mm/19 ms=4.2 m/s=15.2 km/h for this case.

FIG. 5 shows acceleration signals a(10), a(12), a(14) of the three acceleration sensors 10, 12, 14 in the event of an impact at a velocity of 64 km/h against a deformable barrier. The corresponding extreme values of acceleration signals a(10), a(12), a(14) obtained are illustrated in FIG. 6. As is apparent from FIGS. 5 and 6, first acceleration sensor 10 measures an acceleration peak value after approximately 1 ms, while the second acceleration sensor measures an acceleration peak value which is greater than 150 g, after approximately 5 ms. Analyzing and control unit 30 thus ascertains a time difference Δt=4 ms. With the predefined distance d of 80 mm, equation (1) yields a relative accident velocity vᵣₑₗ=80 mm/4 ms=20 m/s=72 km/h.

If this information is made available to a central control unit (not depicted) for triggering the passenger protection arrangement, the signal of an acceleration sensor situated in the central control unit or its integral or other derived quantities may be compared with velocity-dependent thresholds. Triggering of the passenger protection arrangement may thus be prevented in the case of an accident at a velocity of 15 km/h against a rigid wall and a very early triggering in the case of the accident at the velocity of 64 km/h with the deformable barrier may be ensured.

It is very advantageous in particular that the velocity information is available the earlier the higher the velocity. In the event of accidents at very high velocities, a required earlier triggering may thus be ensured.

Additional information may be obtained from signals a(10), a(12), a(14) of acceleration sensors 10, 12, 14 in bumper 20. For example, the start of an accident may thus be determined by establishing the first peak value of one of acceleration signals a(10), a(12), a(14) as the time of impact. As is apparent from the depicted examples, the time of impact may thus be determined with an accuracy of a millisecond. In addition, by comparing acceleration signal a(12) of second acceleration sensor 12 with acceleration signal a(14) of third acceleration sensor 14, it may be recognized whether the impact is symmetrical or asymmetrical. As is apparent from FIG. 4, for example, in the event of a symmetrical impact, the second and third acceleration sensors see a similar acceleration minimum at the same time at approximately 20 ms. As is apparent from FIG. 6, in the case of the asymmetrical accident at a velocity of 64 km/h, second acceleration sensor 12 sees an acceleration peak value at an earlier point in time than third acceleration sensor 14, i.e., at approximately 5 ms, from which it may be concluded that the impact occurred with an offset in the direction of the second measuring point, which is linked to second acceleration sensor 12.

The information generated from the analysis of sensor signals a(10), a(12), and a(14), such as relative accident velocity vᵣₑₗ, time of impact, and symmetry, correspond to the information which may be made available by conventional forward-looking systems such as, for example, radar, lidar, ultrasonic systems, etc., in a pre-crash system. The method according to the present invention makes a triggering decision for the passenger protection arrangement of a comparable quality possible, but at a considerably lower cost than in the case of forward-looking sensor systems. In addition, the method according to the present invention is considerably more robust and less subject to environmental influences and may be used over the entire velocity range and for any objects, while known forward-looking sensor systems may have difficulties at certain velocities and with certain objects, depending on the sensor type. In addition, by using the information of acceleration sensors 10, 12, 14 in bumper 20, the robustness with respect to misuse is considerably increased. A misuse is caused, for example, by bumpy road stretches, driving over the curb, potholes, and the like. Since sensors 10, 12, 14 are situated in bumper 20 and are decoupled from the chassis of the vehicle, they register, in the event of the above-mentioned cases of misuse, virtually no acceleration, so that undesirable triggering of the passenger protection arrangement may be reliably prevented in these situations.

1-13. (canceled)

14. A method for generating a triggering signal for a passenger protection device in which sensor data are detected and analyzed for accident classification, the method comprising:
analyzing, to determine a relative accident velocity, signals of at least two measuring points offset by a predefined distance in an x direction; and
determining a time interval between a crash signal detected by a first sensor at a first measuring point and a crash signal detected by another sensor at another measuring point being determined.

15. The method of claim 14, wherein the sensors are situated at a particular measuring point or coupled to the particular measuring point for detecting the signals.

16. The method of claim 14, wherein the sensors are acceleration sensors, and each crash signal corresponds to a peak value of an acceleration signal detected by a particular acceleration sensor.

17. The method of claim 16, wherein the acceleration signals of at least two acceleration sensors of a pedestrian protection device are analyzed.

18. The method of claim 17, wherein, to determine the relative accident velocity, three measuring points are situated symmetrically on a vehicle bumper, the first measuring point being situated in the center of the vehicle bumper, a second measuring point to the left of the first measuring point in the direction of travel, and a third measuring point to the right of the first measuring point in the direction of travel, the predefined distance corresponding to a perpendicular distance of the first measuring point to an imaginary connecting line between the second measuring point and the third measuring point.

19. The method of claim 14, wherein the relative accident velocity is calculated according to the equation vᵣₑₗ=d/Δt.

20. The method of claim 14, wherein the signals of the at least two measuring points offset by a predefined distance in the x direction are analyzed for determining at least one of a time of impact and a point of impact.

21. The method of claim 14, wherein at least one of the following is satisfied: (i) the point in time of a first crash signal detected by one of the acceleration sensors is output as the time of impact; and (ii) it is recognized, by analyzing the signals of the second and third acceleration sensors, whether a symmetrical impact or an asymmetrical impact has occurred.

22. The method of claim 14, wherein at least one of (i) the determined relative accident velocity, (ii) the determined time of impact, and (iii) the determined symmetry is made available to a subsequent triggering operation for a personal protection arrangement.

23. A device for generating a triggering signal for a passenger protection device, which detects and analyzes sensor data for accident classification, comprising:
at least one first sensor to detect a first signal at a first measuring point;
at least one second sensor to detect a second signal at a second measuring point, which is offset from the first measuring point by a predefined distance in an x direction; and
an analyzing and control unit to analyze the signals of the at least two sensors for determining a relative accident velocity, wherein the analyzing and control unit is operable to determine a time interval between a crash signal detected by the first sensor and a crash signal detected by the second sensor.

24. The device of claim 23, wherein the sensors for detecting the signals are one of (i) situated at the particular measuring point, and (ii) coupled to the particular measuring point.

25. The device of claim 23, wherein the at least two sensors are part of a pedestrian protection device.

26. The device of claim 23, wherein, to determine the relative accident velocity, three acceleration sensors detect the signals of three measuring points situated symmetrically in a vehicle bumper, the first measuring point being situated in a center of the vehicle bumper, a second measuring point to the left of the first measuring point in a direction of travel, and a third measuring point to the right of the first measuring point in the direction of travel, the predefined distance corresponding to a perpendicular distance of the first measuring point to an imaginary connecting line between the second measuring point and the third measuring point.
